(19) United States
(12) Patent Application Publication
(10) Pub. No.: US 2025/0063484 A1
(43) Pub. Date: Feb. 20, 2025

(54) USER EQUIPMENT AND METHOD TO EXEMPT EMERGENCY SERVICES FALLBACK PROCEDURE DUE TO INSECURE STEERING OF ROAMING (SOR)

(71) Applicant: MediaTek Singapore Pte. Ltd., Singapore (SG)

(72) Inventors: Puneet, Bengaluru (IN); Marko Niemi, Oulu (FI)

(21) Appl. No.: 18/763,401

(22) Filed: Jul. 3, 2024

(30) Foreign Application Priority Data
Aug. 17, 2023 (IN) 202321055308

(51) Int. Cl. H04W 48/18; H04W 8/02; H04W 84/04

(52) U.S. Cl. CPC H04W 48/18; H04W 8/02; H04W 84/042

(57) ABSTRACT

A user equipment and a method to exempt emergency services fallback procedure due to insecure steering of roaming (SOR) are provided. The method for operating the UE includes: monitoring an operation of the UE; and allowing the UE to establish a new N1 NAS signaling connection for initiating a registration procedure for an emergency services fallback procedure, during the UE attempts to obtain service on a higher priority PLMN.

This application claims the benefit of India Provisional application No. 202321055308, filed Aug. 17, 2023, the disclosure of which is incorporated by reference herein in its entirety.

### TECHNICAL FIELD

The disclosure relates in general to a user equipment and a method, and more particularly to a user equipment and a method to exempt emergency services fallback procedure due to insecure steering of roaming (SOR).

### BACKGROUND

In the wireless communication technology, the user equipment (UE) could use an emergency services fallback procedure to execute emergency procedure. Support for “Emergency Services Fallback” means the UE is backed off from 5GS (N1 mode) to EPS (S1 mode) for emergency services.

If the 5GS Network indicates “Emergency Services Fallback” support for the TA and RAT where the UE is currently camping, and if the UE supports “emergency services fallback”, the UE shall initiate the Emergency Services Fallback procedure for the emergency session establishment.

The purpose of the control plane solution for steering of roaming in 5GS procedure in a PLMN is to allow the HPLMN to update one or more of the following via NAS signaling.

### SUMMARY

The disclosure is directed to a user equipment and a method to exempt emergency services fallback procedure due to insecure steering of roaming (SOR).

According to one embodiment, a method for operating a user equipment (UE) is provided. The method for operating the UE includes: monitoring an operation of the UE; and allowing the UE to establish a new N1 NAS signaling connection for initiating a registration procedure for an emergency services fallback procedure, during the UE attempts to obtain service on a higher priority PLMN.

According to another embodiment, a method for operating a user equipment (UE) is provided. The method for operating the UE includes: monitoring an operation of the UE; and controlling a receipt of a steering of roaming information not to trigger a release of a N1 NAS signalling connection, if the UE has initiated a registration procedure to perform an emergency services fallback procedure.

According to an alternative embodiment, a user equipment (UE) is provided. The UE includes a transceiver and a processor. The transceiver is configured to wirelessly communicate with a network. The processor is coupled to the transceiver and configured to perform operations comprising: monitoring an operation of the UE; and allowing the UE to establish a new N1 NAS signaling connection for initiating a registration procedure for an emergency services fallback procedure, during the UE attempts to obtain service on a higher priority PLMN

### BRIEF DESCRIPTION OF THE DRAWINGS

FIG. 1 shows a schematic diagram of a mobile communication system according to an embodiment of the present disclosure.

FIG. 2 shows a flowchart of a method for operating the user equipment (UE) according to one embodiment of the present disclosure.

FIGS. 3A to 3C show a stage-2 flow for steering of the user equipment (UE) in VPLMN during registration according to one embodiment of the present disclosure.

FIG. 4 shows a schematic diagram of a mobile communication system according to another embodiment of the present disclosure.

FIG. 5 shows a stage-2 flow for steering of the user equipment (UE) in HPLMN or VPLMN after registration according to one embodiment of the present disclosure.

FIG. 6 illustrates the user equipment (UE) in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

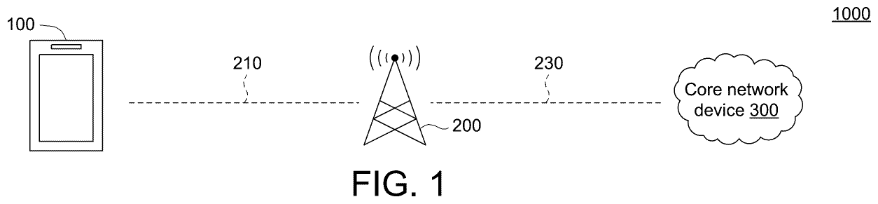

Please refer to FIG. 1, which shows a schematic diagram of a mobile communication system 1000 according to an embodiment of the present disclosure. The mobile communication system 1000 may be a long term evolution (Long Term Evolution, LTE) system, a fifth-generation mobile communication technology 5G new radio (new radio, NR) system, a machine to machine (Machine To Machine, M2M) system, or a future evolved sixth-generation communication system. The mobile communication system 1000 includes a user equipment (UE) 100, a base station 200 and a core network device 300. The base station 200 and the core network device 300 may be collectively referred to as a network device.

In the wireless communication technology, the UE 100 could use an emergency services fallback procedure to execute emergency procedure. Support for “Emergency Services Fallback” means the UE 100 is backed off from 5GS (N1 mode) to EPS (S1 mode) for emergency services.

However, the UE behavior is not defined for the emergency services fallback procedure in below cases:
(1). Whether UE 100 is allowed the establishment of a new N1 NAS signalling connection when the purpose of initiating a registration procedure is an emergency services fallback procedure.
(2). If the UE 100 has initiated the registration procedure to perform an emergency services fallback procedure, then whether UE 100 is allowed to release N1 NAS signalling connection upon the receipt of the steering of roaming information.
(3). If within an implementation dependent time the N1 NAS signalling connection is not released, then the UE 100 is allowed to release the N1 NAS signalling connection locally when the UE 100 has initiated procedure for emergency services fallback procedure.

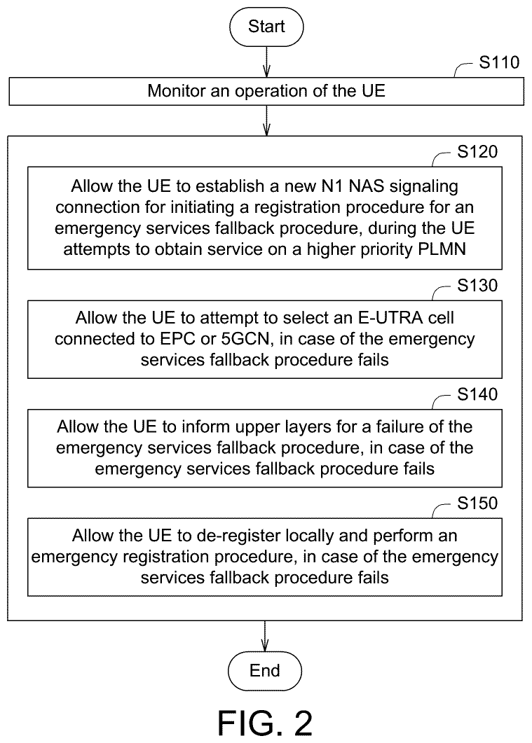

For solving those problems, some solutions are provided as below. Please refer to FIG. 2, which shows a flowchart of a method for operating the user equipment (UE) according to one embodiment of the present disclosure. The method of the for operating the UE 100 includes, for example, steps S110 to S150.

In the step S110, an operation of the UE 100 is monitored. Then, the process proceeds to the step S120, the step S130, the step S140 and/or the step S150.

In the step S120, the UE 100 is allowed to establish a new N1 NAS signaling connection for initiating a registration procedure for the emergency services fallback procedure, during the UE 100 attempts to obtain service on a higher priority PLMN.

In the step S130, the UE 100 is allowed to attempt to select an E-UTRA cell connected to EPC or 5GCN, in case of the emergency services fallback procedure fails.

In the step S140, the UE 100 is allowed to inform upper layers for a failure of the emergency services fallback procedure, in case of the emergency services fallback procedure fails.

In the step S150, the UE 100 is allowed to de-register locally and perform an emergency registration procedure, in case of the emergency services fallback procedure fails.

For example, the method described in the FIG. 2 could be implemented in stage-2 flow for steering of the UE 100 in VPLMN during registration.

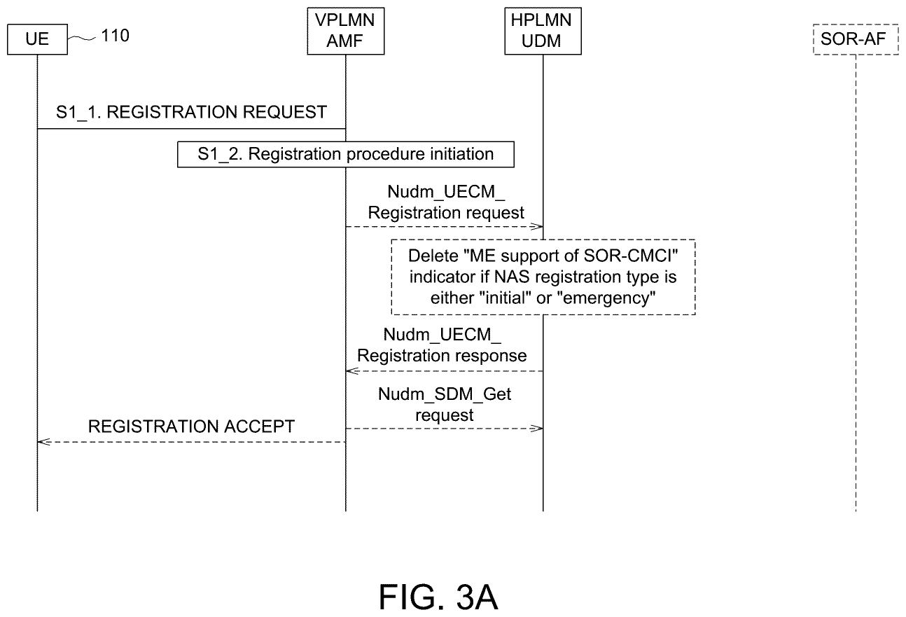

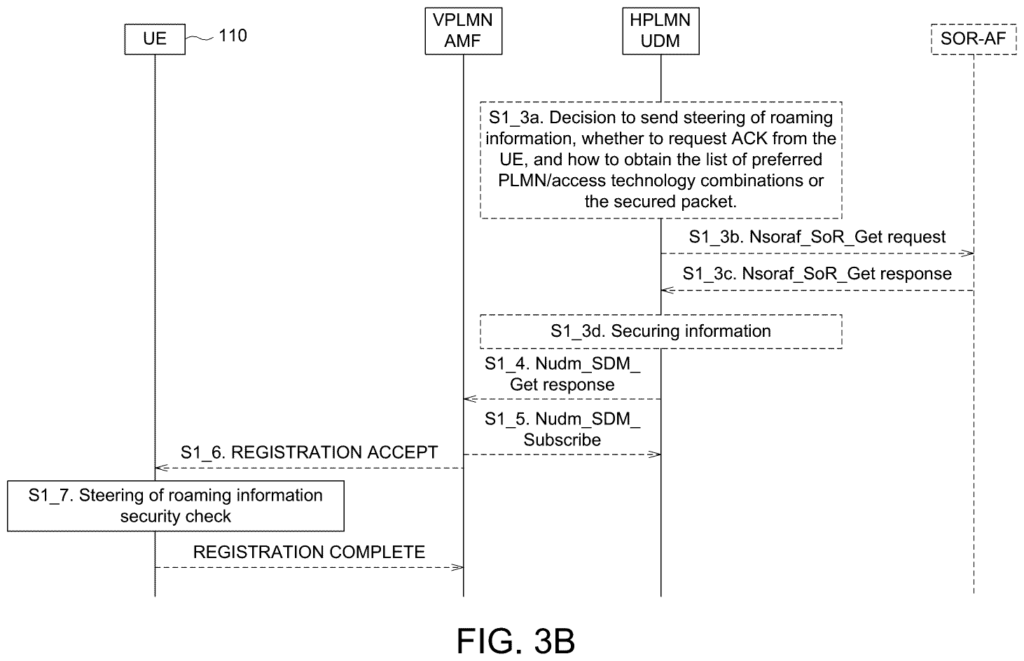

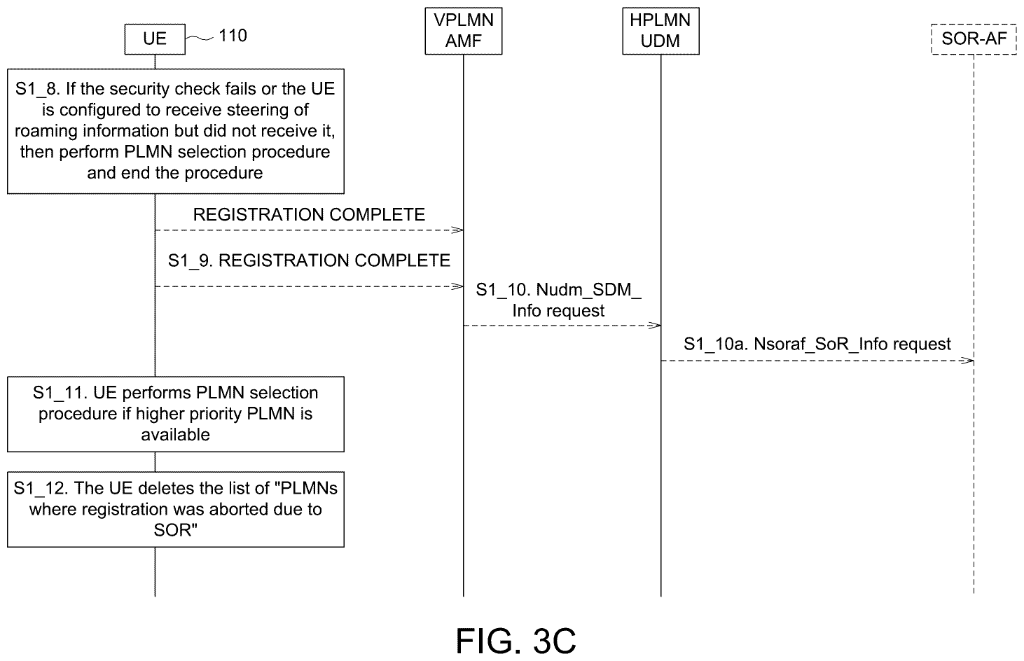

Please refer to FIGS. 3A to 3C, which show the stage-2 flow for steering of the user equipment (UE) 100 in VPLMN during registration according to one embodiment of the present disclosure.

At step S1_1, the UE 100 initiates initial registration, emergency registration or registration procedure for mobility and periodic registration update (see 3GPP TS 24.501) to the VPLMN AMF by sending REGISTRATION REQUEST message with the 5GS registration type IE indicating “initial registration”, “emergency registration” or “mobility registration updating”.

At step S1_2, upon receiving REGISTRATION REQUEST message, the VPLMN AMF executes the registration procedure as defined in clause 4.2.2.2 of 3GPP TS 23.502.

At step S1_3a, if the user subscription information indicates to send the steering of roaming information due to initial registration in a VPLMN, then the HPLMN UDM shall provide the steering of roaming information to the UE 100 when the UE 100 performs initial registration in a VPLMN, otherwise the HPLMN UDM may provide the steering of roaming information to the UE 100, based on operator policy.

At step S1_3b, Nsoraf_SoR_Get request (VPLMN ID, SUPI of the UE 100, access type (see3GPP TS 29.550)).

At step S1_3c, Nsoraf_SoR_Get response.

At step S1_3d, the HPLMN UDM forms the steering of roaming information as specified in 3GPP TS 33.501 from.

At step S1_4, the HPLMN UDM sends a response to the Nudm_SDM_Get service operation to the VPLMN AMF, which includes the steering of roaming information within the Access and Mobility Subscription data.

At step S1_5, as part of the registration procedure, the VPLMN AMF also invokes Nudm_SDM_Subscribe service operation to the HPLMN UDM to subscribe to notification of changes of the subscription data (e.g. received in step 4) including notification of updates of the steering of roaming information included in the Access and Mobility Subscription data (see step 14c in clause 4.2.2.2.2 of 3GPP TS 23.502).

At step S1_6, the VPLMN AMF shall transparently send the received steering of roaming information to the UE 100 in the REGISTRATION ACCEPT message.

At step S1_7, if the steering of roaming information is received and the security check is successful, then:
a) if the UDM has not requested an acknowledgement from the UE 100, then the UE 100 shall send the REGISTRATION COMPLETE message to the serving AMF without including an SOR transparent container;
b) if the steering of roaming information contains a secured packet (see 3GPP TS 31.115):
   the ME shall upload the secured packet to the USIM using procedures in 3GPP TS 31.111, if the service “data download via SMS Point-to-point” is allocated and activated in the USIM Service Table (see 3GPP TS 31.102);
   if the UDM has not requested an acknowledgement from the UE 100 and:
A) the ME receives a USAT REFRESH with command qualifier (3GPP TS 31.111) of type “Steering of Roaming” and either a SOR-CMCI is included, or the UE 100 is configured with the SOR-CMCI, the UE 100 shall perform items a), b) and c) of the procedure for steering of roaming in clause 4.4.6, and if the UE 100 is in automatic network selection mode, then it shall apply the actions in clause C.4.2. In this case steps 8 to 11 are skipped; or
B) the ME receives a USAT REFRESH command qualifier (3GPP TS 31.111) of type “Steering of Roaming” and neither a SOR-CMCI is included, nor the UE 100 is configured with the SOR-CMCI, it shall perform items a), b) and c) of the procedure for steering of roaming in clause 4.4.6 and if:
i) the UE 100 has a list of available and allowable PLMNs in the area and based on this list or any other implementation specific means the UE 100 determines that there is a higher priority PLMN than the selected VPLMN; or
ii) the UE 100 does not have a list of available and allowable PLMNs in the area and is unable to determine whether there is a higher priority PLMN than the selected VPLMN using any other implementation specific means;
and the UE 100 is in automatic network selection mode, then the UE 100 shall either:
i) release the current N1 NAS signalling connection locally and then attempt to obtain service on a higher priority PLMN as specified in clause 4.4.3.3 by acting as if timer T that controls periodic attempts has expired. In this case, steps 8 to 11 are skipped. The UE 100 shall suspend the transmission of 5GSM messages until the N1 NAS signalling is released. The UE 100 shall not initiate the establishment of a new N1 NAS signalling connection, unless for the purpose of initiating a registration procedure for emergency services, establishing an emergency PDU session or performing emergency service fallback until the attempts to obtain service on a higher priority PLMN are completed. If the UE 100 has an established emergency PDU session or is performing emergency services fallback (see 3GPP TS 24.501), the receipt of the steering of roaming information shall not trigger the release of the N1 NAS signalling connection. If camped on a NG-RAN cell, the UE 100 shall release the current N1 NAS signalling connection locally subsequently after the emergency PDU session is released, otherwise the UE 100 shall not take any further actions; or
ii) not release the current N1 NAS signalling connection locally (e.g. if the UE 100 has established PDU session(s)) and skip steps 8 to 10;
c) if the steering of roaming information contains the list of preferred PLMN/access technology combinations, the ME shall replace the highest priority entries in the “Operator Controlled PLMN Selector with Access Technology” list stored in the ME with the received list of preferred PLMN/access technology combinations, and delete the PLMNs identified by the list of preferred PLMN/access technology y combinations from the Forbidden PLMN list and from the Forbidden PLMNs for GPRS service list, if they are present in these lists. Additionally, if:
i) the UE 100 has a list of available and allowable PLMNs in the area and based on this list or any other implementation specific means the UE 100 determines that there is a higher priority PLMN than the selected VPLMN; or
ii) the UE 100 does not have a list of available and allowable PLMNs in the area and is unable to determine whether there is a higher priority PLMN than the selected VPLMN using any other implementation specific means;
and the UE 100 is in automatic network selection mode:
A) if the UE 100 is configured with the SOR-CMCI or received the SOR-CMCI over N1 NAS signalling, the UE 100 shall apply the actions in clause C.4.2. In this case steps 8 to 11 are skipped;
B) otherwise, the UE 100 shall:
i) release the current N1 NAS signalling connection locally and then attempt to obtain service on a higher priority PLMN as specified in clause 4.4.3.3 by acting as if timer T that controls periodic attempts has expired. In this case, steps 8 to 11 are skipped. The UE 100 shall suspend the transmission of 5GSM messages until the N1 NAS signalling is released. The UE 100 shall not initiate the establishment of a new N1 NAS signalling connection, unless for the purpose of initiating a registration procedure for emergency services, establishing an emergency PDU session or performing emergency services fallback, until the attempts to obtain service on a higher priority PLMN are completed. If the UE 100 has an established emergency PDU session or is performing emergency services fallback (see 3GPP TS 24.501), the receipt of the steering of roaming information shall not trigger the release of the N1 NAS signalling connection. If camped on a NG-RAN cell, he UE 100 shall release the current N1 NAS signalling connection locally subsequently after the emergency PDU session is released, otherwise the UE 100 shall not take any further actions. If the UE 100 needs to disable the N1 mode capability (see 3GPP TS 24.501) and there is no emergency service pending, the UE 100 shall first attempt to obtain service on a higher priority PLMN as described in this step, and if no higher priority PLMN can be selected but the last registered PLMN is selected, then the UE 100 shall disable the N1 mode capability; or
ii) not release the current N1 NAS signalling connection locally (e.g. if the UE 100 has established PDU session(s)) and skip steps 8 to 10.

At step S1_8, if the USIM of the UE 100 is configured with indication that the UE 100 is to receive the steering of roaming information due to initial registration in a VPLMN, but neither the list of preferred PLMN/access technology combinations nor the secured packet nor the HPLMN indication that ‘no change of the “Operator Controlled PLMN Selector with Access Technology” list stored in the UE 100 is needed and thus no list of preferred PLMN/access technology combinations is provided’ is received in the REGISTRATION ACCEPT message, when the UE 100 performs initial registration in a VPLMN or if the steering of roaming information is received but the security check is not successful, then the UE 100 shall:
a) if the SOR transparent container is included in the REGISTRATION ACCEPT message, send the REGISTRATION COMPLETE message to the serving AMF without including an SOR transparent container;
b) if the current chosen VPLMN is not contained in the list of “PLMNs where registration was aborted due to SOR”, and is not part of “User Controlled PLMN Selector with Access Technology” list and the UE 100 is not in manual mode of operation:
i) if the steering of roaming information is received but the security check is not successful when the UE 100 performs registration procedure for mobility and periodic registration update (see 3GPP TS 24.501) in a VPLMN and the UE 100 has a stored SOR-CMCI, and there are ongoing PDU sessions or services, the UE 100 shall apply the actions in clause C.4.2. In this case, current PLMN is considered as lowest priority and steps 9 to 11 are skipped;
ii) otherwise, the UE 100 shall release the current N1 NAS signalling connection locally and attempt to obtain service on a higher priority PLMN as specified in clause 4.4.3.3 by acting as if timer T that controls periodic attempts has expired, with an exception that the current PLMN is considered as lowest priority, and skip steps 9 to 11. The UE 100 shall suspend the transmission of 5GSM messages until the N1 NAS signalling is released. The UE 100 shall not initiate the establishment of a new N1 NAS signalling connection, unless for the purpose of initiating a registration procedure for emergency services, establishing an emergency PDU session or performing emergency services fallback until the attempts to obtain service on a higher priority PLMN are completed. If the UE 100 has an established emergency PDU session (see 3GPP TS 24.501), if camped on a NG-RAN cell, the UE 100 shall release the current N1 NAS signalling connection locally after the release of the emergency PDU session, otherwise the UE 100 shall not take any further actions. If the UE 100 needs to disable the N1 mode capability (see 3GPP TS 24.501 [64]) and there is no emergency service pending, the UE 100 shall first attempt to obtain service on a higher priority PLMN as described in this step, and if no higher priority PLMN can be selected but the last registered PLMN is selected, then the UE 100 shall disable the N1 mode capability; and
c) if the current chosen VPLMN is not contained in the list of “PLMNs where registration was aborted due to SOR”, store the PLMN identity in the list of “PLMNs where registration was aborted due to SOR”.

At step S1_9, if the UDM has requested an acknowledgement from the UE 100 and the UE 100 verified that the steering of roaming information has been provided by the HPLMN in step S1_7, then the UE 100 sends the REGISTRATION COMPLETE message.

At step S1_10, if an SOR transparent container is received in the REGISTRATION COMPLETE message, the AMF uses the Nudm_SDM_Info service operation to provide the received SOR transparent container to the UDM.

At step S1_10a, Nsoraf_SoR_Info (SUPI of the UE 100, successful delivery, “ME support of SOR-CMCI” indicator, if any, “ME support of SOR-SNPN-SI” indicator, if any, “ME support of SOR-SNPN-SI-LS” indicator, if any) is provided the SOR-AF.

At step S1_11, if the UE 100 has a list of available PLMNs in the area and based on this list the UE 100 determines that there is a higher priority PLMN than the selected VPLMN and the UE 100 is in automatic network selection mode, then the UE 100 shall attempt to obtain service on a higher priority PLMN as specified in clause 4.4.3.3 by acting as if timer T that controls periodic attempts has expired after the release of the N1 NAS signalling connection.

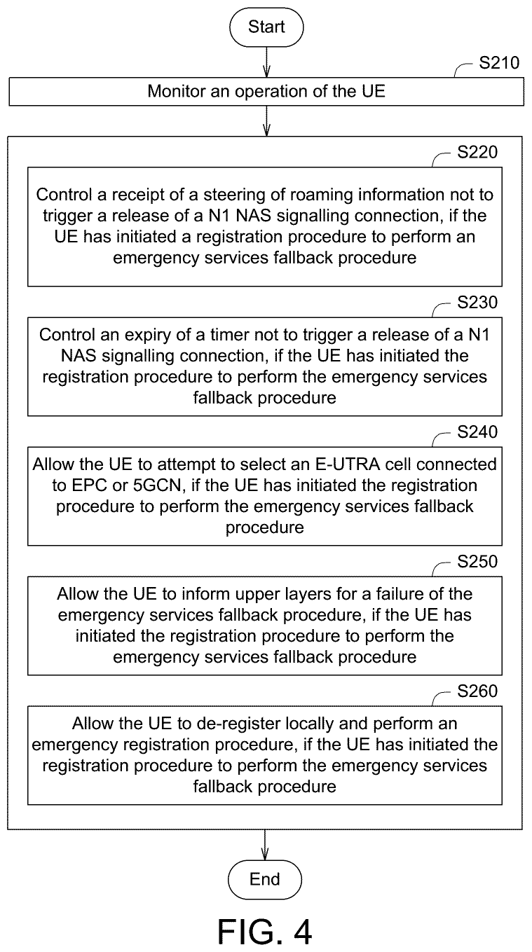

Please refer to FIG. 4, which shows a schematic diagram of a mobile communication system according to another embodiment of the present disclosure. The method of the for operating the user equipment (UE) 100 includes, for example, steps S210 to S260.

In the step S210, the operation of the UE 100 is monitored. Then, the process proceeds to the step S220, the step S230, the step S240, the step S250 and/or the step S260.

In the step S220, a receipt of a steering of roaming information is controlled not to trigger a release of a N1 NAS signalling connection, if the UE 100 has initiated a registration procedure to perform an emergency services fallback procedure.

In the step S230, an expiry of a timer is controlled not to trigger a release of a N1 NAS signalling connection, if the UE 100 has initiated the registration procedure to perform the emergency services fallback procedure.

In the step S240, the UE 100 is allowed to attempt to select an E-UTRA cell connected to EPC or 5GCN, if the UE 100 has initiated the registration procedure to perform the emergency services fallback procedure.

In the step S250, the UE 100 is allowed to inform upper layers for a failure of the emergency services fallback procedure, if the UE 100 has initiated the registration procedure to perform the emergency services fallback procedure.

In the step S260, the UE 100 is allowed to de-register locally and perform an emergency registration procedure, if the UE 100 has initiated the registration procedure to perform the emergency services fallback procedure.

For example, the method described in the FIG. 4 could be implemented in stage-2 flow for steering of the user equipment (UE) 100 in HPLMN or VPLMN after registration.

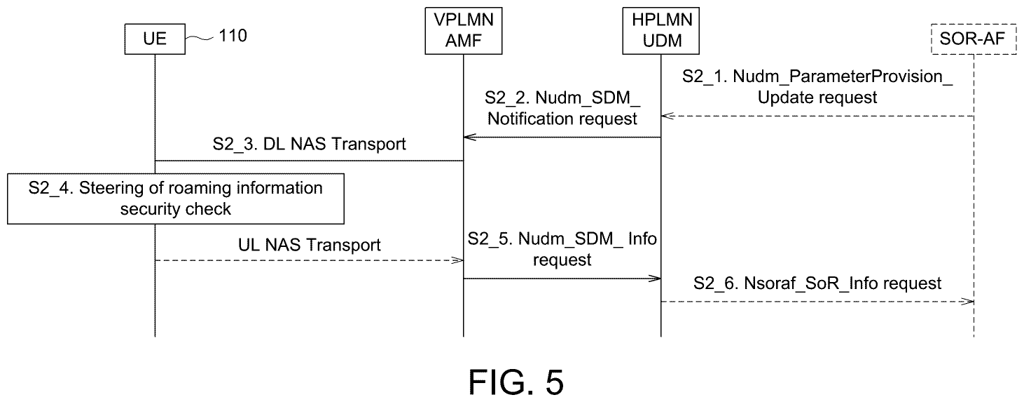

Please refer to FIG. 5, which shows the stage-2 flow for steering of the user equipment (UE) 100 in HPLMN or VPLMN after registration according to one embodiment of the present disclosure.

At step S2_1, Nudm_ParameterProvision_Update request is sent to the HPLMN UDM to trigger the update of the UE 100 with the new list of preferred PLMN/access technology combinations, the SOR-CMCI, if any, and the “Store SOR-CMCI in ME” indicator, if any, or a secured packet for a UE 100 identified by SUPI.

At step S2_2, the UDM notifies the changes of the user profile to the affected AMF by the means of invoking Nudm_SDM_Notification service operation.

At step S2_3, the AMF sends a DL NAS TRANSPORT message to the served UE 100.

At step S2_4, upon receiving the steering of roaming information, the UE 100 shall perform a security check on the steering of roaming information included in the DL NAS

TRANSPORT message to verify that the steering of roaming information is provided by HPLMN, and:
if the security check is successful and:
a) if the steering of roaming information contains a secured packet (see 3GPP TS 31.115 [67]) and the service “data download via SMS Point-to-point” is allocated and activated in the USIM Service Table (see 3GPP TS 31.102 [40]), the ME shall upload the secured packet to the USIM using procedures in 3GPP TS 31.111 [41].

If the UDM has requested an acknowledgement from the UE 100 in the DL NAS TRANSPORT message and the ME receives UICC responses indicating that the UICC has received the secured packet successfully, then the UE 100 sends an UL NAS TRANSPORT message to the serving AMF with an SOR transparent container including the UE 100 acknowledgement and the UE 100:
shall set the “ME support of SOR-CMCI” indicator in the header of the SOR transparent container to “supported”;
may set the “ME support of SOR-SNPN-SI” indicator in the header of the SOR transparent container to “supported” if the UE 100 supports access to an SNPN using credentials from a credentials holder; and
shall set the “ME support of SOR-SNPN-SI-LS” indicator in the header of the SOR transparent container to “supported” if the UE 100 supports access to an SNPN providing access for localized services in SNPN; and
when the ME receives a USAT REFRESH command qualifier (see 3GPP TS 31.111 [41]) of type “Steering of Roaming” and neither a SOR-CMCI is included, nor the UE 100 is configured with the SOR-CMCI, it performs the procedure for steering of roaming in clause 4.4.6 with an exception that if the UE 100 is in automatic network selection mode, then the UE 100 shall wait until it moves to idle mode or 5GMM-CONNECTED mode with RRC inactive indication (see 3GPP TS 24.501 [64]) before attempting to obtain service on a higher priority PLMN (specified in clause 4.4.6 bullet d); or
when the ME receives a USAT REFRESH with command qualifier (see 3GPP TS 31.111 [41]) of type “Steering of Roaming” and either a SOR-CMCI is included, or the UE 100 is configured with the SOR-CMCI, the UE 100 shall perform items a), b) and c) of the procedure for steering of roaming in clause 4.4.6. If the UE 100 is in automatic network selection mode it shall apply the actions in clause C.4.2;
b) if the steering of roaming information contains the list of preferred PLMN/access technology combinations, the ME shall replace the highest priority entries in the “Operator Controlled PLMN Selector with Access Technology” list stored in the ME with the received list of preferred PLMN/access technology combinations, and delete the PLMNs identified by the list of preferred PLMN/access technology combinations from the Forbidden PLMN list and from the Forbidden PLMNs for GPRS service list, if they are present in these lists.

If the UDM has requested an acknowledgement from the UE 100 in the DL NAS TRANSPORT message, the UE 100 sends an UL NAS TRANSPORT message to the serving AMF with an SOR transparent container including the UE 100 acknowledgement and the UE 100:
shall set the “ME support of SOR-CMCI” indicator to “supported”
may set the “ME support of SOR-SNPN-SI” indicator in the header of the SOR transparent container to “supported” if the UE 100 supports access to an SNPN using credentials from a credentials holder; and
shall set the “ME support of SOR-SNPN-SI-LS” indicator in the header of the SOR transparent container to “supported” if the UE 100 supports access to an SNPN providing access for localized services in SNPN.

If the UE 100 is in automatic network selection mode and the selected PLMN is a VPLMN, then:
if the UE 100 has a stored SOR-CMCI or received the SOR-CMCI over N1 NAS signalling, the UE 100 shall apply the actions in clause C.4; or
the UE 100 shall wait until it moves to idle mode or 5GMM-CONNECTED mode with RRC inactive indication (see 3GPP TS 24.501 [64]) before attempting to obtain service on a higher priority PLMN as specified in clause 4.4.3.3 by acting as if timer T that controls periodic attempts has expired. The UE 100 shall not initiate the establishment of a new N1 NAS signalling connection, unless for the purpose of initiating a registration procedure for emergency services, emergency services fallback or establishing an emergency PDU session, until the attempts to obtain service on a higher priority PLMN are completed.

If the selected PLMN is a VPLMN and the UE 100 has an established emergency PDU session then the UE 100 shall attempt to perform the PLMN selection subsequently after the emergency PDU session is released, if the UE 100 is in automatic network selection mode.

If the UDM has not requested an acknowledgement from the UE 100, then step 5 is skipped; and
if the selected PLMN is a VPLMN, the security check is not successful and the UE 100 is in automatic network selection mode, then:
if the UE 100 has a stored SOR-CMCI, the current PLMN is considered as lowest priority and the UE 100 shall apply the actions in clause C.4.2; or
if there are ongoing PDU sessions or services, the UE 100 shall apply the actions in clause C.4.2; or
the UE 100 shall release the current N1 NAS signalling connection locally and attempt to obtain service on a higher priority PLMN as specified in clause 4.4.3.3 by acting as if timer T that controls periodic attempts has expired. The UE 100 shall not initiate the establishment of a new N1 NAS signalling connection, unless for the purpose of initiating a registration procedure for emergency services, establishing an emergency PDU session or performing emergency services fallback, until the attempts to obtain service on a higher priority PLMN are completed;
if the UE 100 does not have a stored SOR-CMCI, then:
if there are ongoing PDU sessions or services, the UE 100 shall wait until it moves to idle mode or 5GMM-CONNECTED mode with RRC inactive indication (see 3GPP TS 24.501 [64]) before attempting to obtain service on a higher priority PLMN as specified in clause 4.4.3.3 by acting as if timer T that controls periodic attempts has expired, with an exception that the current PLMN is considered as lowest priority. The UE 100 shall not initiate the establishment of a new N1 NAS signalling connection, unless for the purpose of initiating a registration procedure for emergency services, establishing an emergency PDU session or performing emergency services fallback, until the attempts to obtain service on a higher priority PLMN are completed. If the selected PLMN is a VPLMN and the UE 100 has an established emergency PDU session, then the UE 100 shall attempt to perform the PLMN selection after the emergency PDU session is released; or
if there are no ongoing PDU sessions or services, the UE 100 shall release the current N1 NAS signalling connection locally and attempt to obtain service on a higher priority PLMN as specified in clause 4.4.3.3 by acting as if timer T that controls periodic attempts has expired, with an exception that the current PLMN is considered as lowest priority. The UE 100 shall not initiate the establishment of a new N1 NAS signalling connection, unless for the purpose of initiating a registration procedure for emergency services, establishing an emergency PDU session or performing emergency services fallback, until the attempts to obtain service on a higher priority PLMN are completed.
   Step S2_5 is skipped;

At step S2_5, if the UL NAS TRANSPORT message with an SOR transparent container is received, the AMF uses the Nudm_SDM_Info service operation to provide the received SOR transparent container to the UDM.

At step S2_6, Nsoraf_SoR_Info (SUPI of the UE 100, successful delivery, “ME support of SOR-CMCI” indicator, if any, “ME support of SOR-SNPN-SI” indicator, if any, “ME support of SOR-SNPN-SI-LS” indicator, if any).

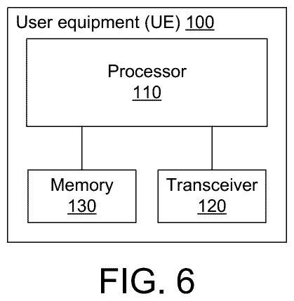

FIG. 6 illustrates the user equipment (UE) 100 in accordance with an implementation of the present disclosure. The user equipment 100 may perform various functions to implement schemes, techniques, processes and methods described herein pertaining to UE behavior in mobile communications, including the various schemes described above with respect to various proposed designs, concepts, schemes, systems and methods described above, including the network environment, as well as processes described below.

The UE 100 may be a part of an electronic apparatus, which may be a network apparatus, such as a portable or mobile apparatus, a wearable apparatus, a vehicular device or a vehicle, a wireless communication apparatus or a computing apparatus. For instance, the UE 100 may be implemented in a smartphone, a smart watch, a personal digital assistant, an electronic control unit (ECU) in a vehicle, a digital camera, or a computing equipment such as a tablet computer, a laptop computer or a notebook computer. The user equipment may also be a part of a machine type apparatus, which may be an IoT apparatus such as an immobile or a stationary apparatus, a home apparatus, a roadside unit (RSU), a wire communication apparatus or a computing apparatus. For instance, the UE 100 may be implemented in a smart thermostat, a smart fridge, a smart door lock, a wireless speaker or a home control center. When implemented in or as a network apparatus, the UE 100 may be implemented in an eNodeB in an LTE, LTE-Advanced or LTE-Advanced Pro network or in a gNB or TRP in a 5G network, an NR network or an IoT network.

In some implementations, the UE 100 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the UE 100 may be implemented in or as a network apparatus. The UE 100 may include at least some of those components shown in the FIG. 4, such as a processor 110, a transceiver 120 and a memory 130, for example. The UE 100 may further include one or more other components not pertinent to the proposed scheme of the present disclosure (e.g., internal power supply, display device and/or user interface device).

In one aspect, the processor 110 may be implemented in the form of one or more single-core processors, one or more multi-core processors, or one or more CISC or RISC processors. That is, even though a singular term “a processor” is used herein to refer to the processor 110, the processor 110 may include multiple processors in some implementations and a single processor in other implementations in accordance with the present disclosure. In another aspect, the processor 110 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the UE 100 behavior for failed registration and service requests for emergency services fallback in mobile communications in accordance with various implementations of the present disclosure.

The transceiver 120 is coupled to the processor 110. The transceiver 120 may be capable of wirelessly transmitting and receiving data. In some implementations, the transceiver 120 may be capable of wirelessly communicating with different types of wireless networks of different radio access technologies (RATs). In some implementations, the transceiver 120 may be equipped with a plurality of antenna ports (not shown) such as, for example, four antenna ports. That is, the transceiver 120 may be equipped with multiple transmit antennas and multiple receive antennas for multiple-input multiple-output (MIMO) wireless communications.

The memory 130 is coupled to the processor 110 and stores data therein. The memory 130 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 130 may include a type of non-volatile random-access memory (NVRAM) such as flash memory, solid-state memory, ferroelectric RAM (FeRAM), magnetoresistive RAM (MRAM) and/or phase-change memory.

The processor 110 of the UE 100, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for operating a user equipment (UE), comprising:
monitoring an operation of the UE; and
allowing the UE to establish a new N1 NAS signaling connection for initiating a registration procedure for an emergency services fallback procedure, during the UE attempts to obtain service on a higher priority PLMN.

2. The method according to claim 1, further comprising:
allowing the UE to attempt to select an E-UTRA cell connected to EPC or 5GCN, in case of the emergency services fallback procedure fails.

3. The method according to claim 1, further comprising:
allowing the UE to inform upper layers for a failure of the emergency services fallback procedure, in case of the emergency services fallback procedure fails.

4. The method according to claim 1, further comprising:
allowing the UE to de-register locally and perform an emergency registration procedure, in case of the emergency services fallback procedure fails.

5. A method for operating a user equipment (UE), comprising:
monitoring an operation of the UE; and
controlling a receipt of a steering of roaming information not to trigger a release of a N1 NAS signalling connection, if the UE has initiated a registration procedure to perform an emergency services fallback procedure.

6. The method according to claim 5, further comprising:
controlling an expiry of a timer not to trigger a release of a N1 NAS signalling connection, if the UE has initiated the registration procedure to perform the emergency services fallback procedure.

7. The method according to claim 5, further comprising:
allowing the UE to attempt to select an E-UTRA cell connected to EPC or 5GCN, if the UE has initiated the registration procedure to perform the emergency services fallback procedure.

8. The method according to claim 5, further comprising:
allowing the UE to inform upper layers for a failure of the emergency services fallback procedure, if the UE has initiated the registration procedure to perform the emergency services fallback procedure.

9. The method according to claim 5, further comprising:
allowing the UE to de-register locally and perform an emergency registration procedure, if the UE has initiated the registration procedure to perform the emergency services fallback procedure.

10. A user equipment (UE), comprising:
a transceiver, configured to wirelessly communicate with a network; and
a processor, coupled to the transceiver and configured to perform operations comprising:
monitoring an operation of the UE; and
allowing the UE to establish a new N1 NAS signaling connection for initiating a registration procedure for an emergency services fallback procedure, during the UE attempts to obtain service on a higher priority PLMN.

11. The user equipment (UE) according to claim 10, wherein the operations further comprise:
allowing the UE to attempt to select an E-UTRA cell connected to EPC or 5GCN, in case of the emergency services fallback procedure fails.

12. The user equipment (UE) according to claim 10, wherein the operations further comprise:
allowing the UE to inform upper layers for a failure of the emergency services fallback procedure, in case of the emergency services fallback procedure fails.

13. The user equipment (UE) according to claim 10, wherein the operations further comprise:
allowing the UE to de-register locally and perform an emergency registration procedure, in case of the emergency services fallback procedure fails.

14. The user equipment (UE) according to claim 10, wherein the operations further comprise:
controlling a receipt of a steering of roaming information not to trigger a release of a N1 NAS signalling connection, if the UE has initiated the registration procedure to perform the emergency services fallback procedure.

15. The user equipment (UE) according to claim 14, wherein the operations further comprise:
controlling an expiry of a timer not to trigger a release of a N1 NAS signalling connection, if the UE has initiated the registration procedure to perform the emergency services fallback procedure.

16. The user equipment (UE) according to claim 14, wherein the operations further comprise:
allowing the UE to attempt to select an E-UTRA cell connected to EPC or 5GCN, if the UE has initiated the registration procedure to perform the emergency services fallback procedure.

17. The user equipment (UE) according to claim 14, wherein the operations further comprise:
allowing the UE to inform upper layers for a failure of the emergency services fallback procedure, if the UE has initiated the registration procedure to perform the emergency services fallback procedure.

18. The user equipment (UE) according to claim 14, wherein the operations further comprise:
allowing the UE to de-register locally and perform an emergency registration procedure, if the UE has initiated the registration procedure to perform the emergency services fallback procedure.
